(19) United States
(12) Patent Application Publication
(10) Pub. No.: US 2021/0282340 A1
(43) Pub. Date: Sep. 16, 2021

(54) CROSS-FLOW VACUUM AND CUTTER

(71) Applicant: HRM Enterprises, Inc., Westerly, RI (US)

(72) Inventors: Richard Zerbarini, Westerly, RI (US); Paul Zerbarini, Westerly, RI (US); Robert Zerbarini, Westerly, RI (US); David Jalbert, Coventry, RI (US)

(21) Appl. No.: 17/196,741

(22) Filed: Mar. 9, 2021

Related U.S. Application Data
(60) Provisional application No. 62/987,123, filed on Mar. 9, 2020.

(51) Int. Cl. A01G 20/47; A47L 7/00; A47L 7/02; A47L 5/28; A47L 9/14; A47L 9/00; A01D 43/063; A01D 34/43; B26D 5/08

(52) U.S. Cl. CPC A01G 20/47; A47L 7/0095; A47L 7/02; A47L 5/28; A01D 2101/00; A47L 9/009; A01D 43/0636; A01D 34/43; B26D 5/08; A47L 9/1418

(57) ABSTRACT

A yard waste clearing device includes a horizontal cross-flow fan blade assembly. The cross-flow fan blade assembly is disposed in a housing that operated in concert to produce an airflow from an inlet portion of the housing, through the cross-flow fan blade assembly, and out an outlet portion with a sufficient flow rate to carry plant matter shredded by the cross-flow fan blade assembly to a storage element such as a disposable yard waste bag. A vertical chute from the outlet portion carries the shredded plant matter up to the opening of the yard waste bag so that the yard waste bag may be held vertically, utilizing the available storage space more efficiently.

### PRIORITY

The present application claims the benefit under 35 U.S.C. § 119(e) of U.S. Provisional App. No. 62/987,123 (filed Mar. 9, 2020), which is incorporated herein by reference.

### BACKGROUND

Yard waste clearing devices generally take the form of large vacuums. Such vacuums are heavy and awkward. In order to be mobile, they generally require heavy, loud internal combustion engines, or battery powered motors that only last a short time. Furthermore, they are inefficient at storing yard waste and must be emptied often. It would be advantageous to have a yard waste clearing device that was smaller, more mobile, and more energy and space efficient than existing solutions.

### SUMMARY

In one aspect, embodiments of the inventive concepts disclosed herein are directed to a yard waste clearing device having a horizontal cross-flow fan blade assembly. The cross-flow fan blade assembly is disposed in a housing that operated in concert to produce an airflow from an inlet portion of the housing, through the cross-flow fan blade assembly, and out an outlet portion with a sufficient flow rate to carry plant matter shredded by the cross-flow fan blade assembly to a storage element.

In a further aspect, the storage element comprises a disposable yard waste bag. A vertical chute from the outlet portion carries the shredded plant matter up to the opening of the yard waste bag so that the yard waste bag may be held vertically.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a cross-sectional view of a cross-flow fan component of a yard waste clearing device according to an exemplary embodiment;

FIG. 2A shows a perspective view of a yard waste clearing device according to an exemplary embodiment;

FIG. 2B shows a perspective view of a yard waste clearing device according to an exemplary embodiment;

FIG. 2C shows a side view of a yard waste clearing device according to an exemplary embodiment;

FIG. 3 shows a perspective view of a yard waste clearing device according to an exemplary embodiment;

FIG. 4 shows a side view of a blade assembly according to an exemplary embodiment;

FIG. 5 shows examples of grass cut quality utilizing varieties of mowers;

FIG. 6 shows a graph of cut quality degradation due to blade dulling over acres cut;

FIG. 7A shows a perspective view of a robot mowing device according to an exemplary embodiment;

FIG. 7B shows a perspective view of a robot mowing device according to an exemplary embodiment;

FIG. 7C shows a perspective view of a robot mowing device according to an exemplary embodiment;

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to a yard waste clearing device having a horizontal cross-flow fan blade assembly. The cross-flow fan blade assembly is disposed in a housing that operated in concert to produce an airflow from an inlet portion of the housing, through the cross-flow fan blade assembly, and out an outlet portion with a sufficient flow rate to carry plant matter shredded by the cross-flow fan blade assembly to a storage element such as a disposable yard waste bag. A vertical chute from the outlet portion carries the shredded plant matter up to the opening of the yard waste bag so that the yard waste bag may be held vertically, utilizing the available storage space more efficiently.

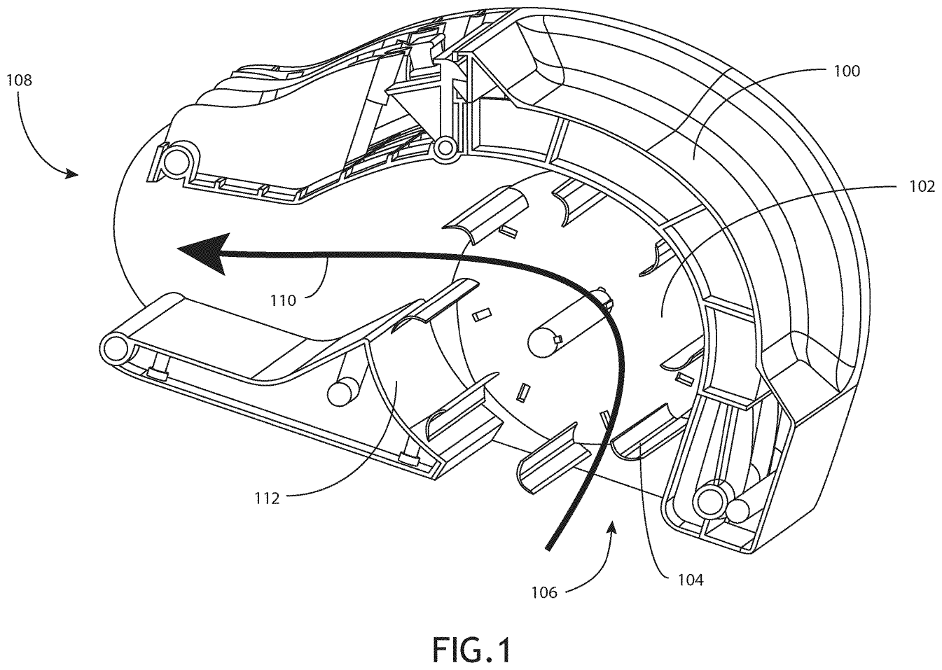

Referring to FIG. 1, a cross-sectional view of a cross-flow fan component of a yard waste clearing device according to an exemplary embodiment is shown. A housing 100 defines an internal blade assembly chamber. The blade assembly chamber contains a horizontally rotating cross-flow fan blade assembly 102. The cross-flow fan blade assembly 102 comprises a plurality of airfoil blades 104, each having a cutting edge on a leading surface. The cross-flow fan blade assembly 102 produces an airflow 110 from an opening, inlet portion 106 to an outlet portion 108. In at least one embodiment, the blade assembly chamber may be further defined by a curved rear surface 112 disposed to reduce turbulence in the airflow 110. An airfoil cross section enhances airflow through the cross-flow fan blade assembly 102, and also enhances rigidity of the airfoil blades 104.

Plant matter such as leaves is drawn in through the inlet portion 106 by the airflow 110 and is shredded by the airfoil blades 104. The plant matter may be repeatedly shredded into smaller and pieces within the cross-flow fan blade assembly 102 until small enough to remain effectively suspended within the airflow 110. At that time, the shredded plant matter is carried out the outlet portion 108.

In at least one embodiment, either the inlet portion 106 to receive plant matter or the enclosed cross-flow fan blade assembly 102 may be disposed a specific distance from the ground via the wheels such that the airflow into the inlet portion 106 is sufficient to draw leaves and small plant matter in, but allow heavier material, such as stones or branches to fall out. Alternatively, or in addition, the wheels may be adjustable to raise or lower the housing to increase or decrease airflow proximal to the ground. Alternatively, or in addition, the cross-flow fan opening may include a guard to exclude matter above a certain size to prevent damage to the cutting blades.

In at least one embodiment, the cross-flow fan blade assembly may be 10 inches wide, but additional embodiments are envisioned. In at least one embodiment, the cross-flow fan blade assembly may be modular to allow increased width via additional cutter sections. A 15-inch embodiment may have four rotors with three cutter sections. A 20-inch embodiment may include additional rotor and cutting section. The disc diameter may be 3.6 inches. By comparison the same system configured with 6-inch diameter discs may have three rotors and two cutting sections.

A cross-flow fan blade assembly 102 according to exemplary embodiments may include airfoil blades 104 that are manufactured using a low cost continuous in-line process from inexpensive coils of strip steel, such as used in band saw blades, utility knife blades, or razor blades. Blade thickness is thin (less than 0.075 inches). Thin blades are advantageous to blade longevity. In some embodiments, a cross-flow fan blade assembly 102 with unsharpened blades between 0.032 inches and 0.035 inches thick and having no cutting edge were shown to be sharper than slightly used rotary blades.

In at least one embodiment, each airfoil blade 104 of a cross-flow fan blade assembly 102 comprises a hardened cutting edge with Rockwell hardness above 60 to a depth of 0.035 inches, and a softer body of Rockwell hardness below 58 for the remainder of the blade.

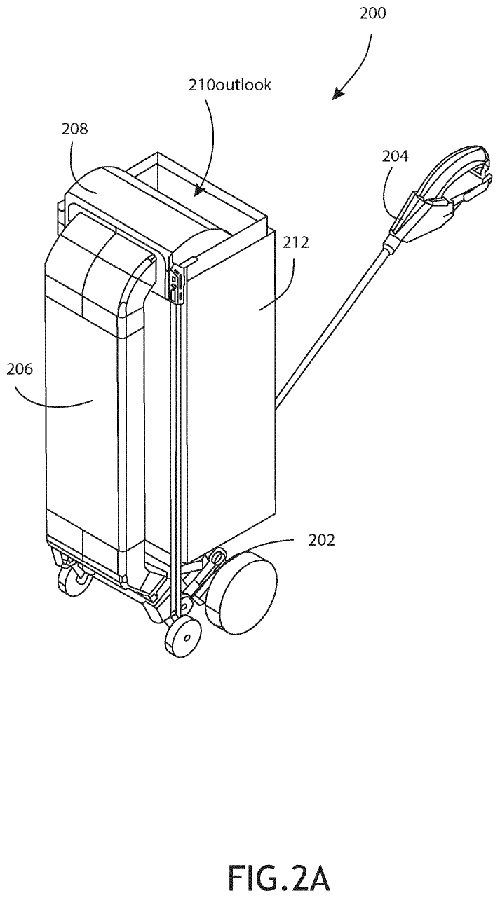

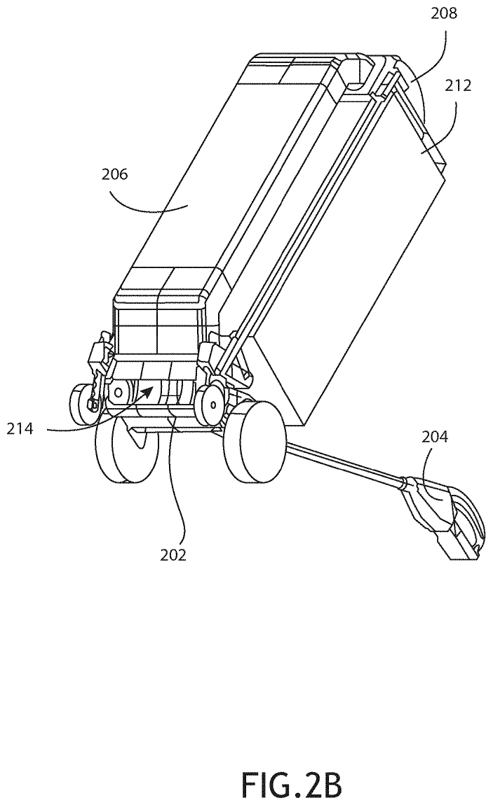

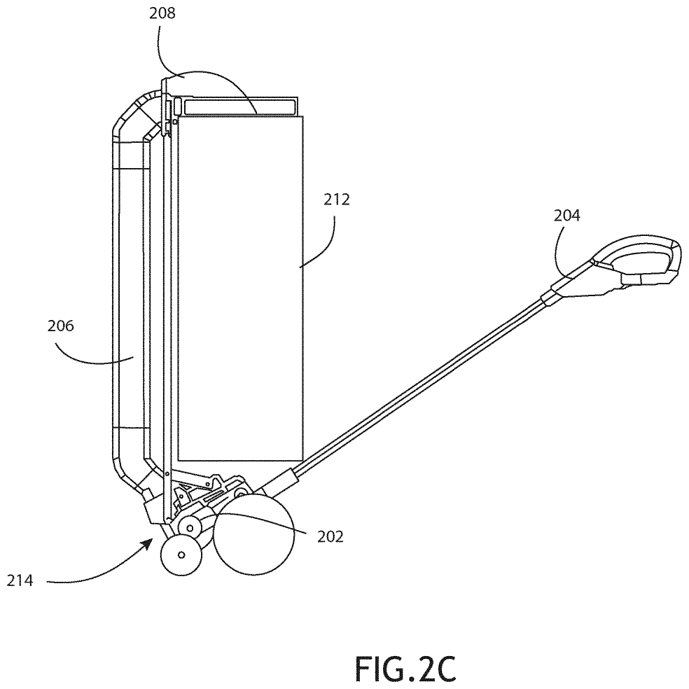

Referring to FIGS. 2A-2C, perspective views and a side view of a yard waste clearing device 200 according to an exemplary embodiment is shown. The yard waste clearing device 200 includes a cross-flow fan cutting assembly having airfoil shaped blades that rotate about a horizontal axis, and control column 204 to allow steering. The control column may also include a battery port or plug. In at least one embodiment, the yard waste clearing device 200 may include a yard waste bag platform (obscured) for holding a yard waste bag 212 in a desired position and orientation, and a chute 206 leading from an outlet portion of the cross-flow fan housing 202 to the yard waste bag 212. The chute 206 may have a substantially constant cross-section to maintain a constant airflow rate; that constant airflow rate being sufficient to carry shredded plant matter the entire vertical distance of the chute 206. The yard waste bag platform may be disposed to maintain the yard waste bag in an upright or nearly upright orientation during operation. In at least one embodiment, the yard waste bag platform and chute may be adjustable within a range to maintain a desired orientation of the yard waste bag 212. In at least one embodiment, the chute 206 may include a top assembly 208 to direct shredded plant matter into a yard waste bag opening 210.

In at least one embodiment, the yard waste bag platform may include structures to secure the yard waste bag 212 in place, and hold the yard waste bag opening 210 open. Such structures may include adjustable metal frame elements positively attaching the yard waste bag 212 to the chute 206.

Furthermore, the cross-flow fan housing 202 may include wheels to roll along the ground and collect plant matter at aa height determined by a desired airflow into the housing. Such wheels may be adjustable to control the airflow pressure. In such embodiment, shredded plant matter may need to travel a significant vertical distance to enter an upright yard waste bag 212. The cross-flow fan must therefore be configured for sufficient airflow, and sufficient shredding efficiency, to produce shredded plant matter that can be carried that vertical distance by the airflow to reach the yard waste bag. In at least one embodiment, the airflow may be sufficient to draw unshredded plant matter from the ground, a short distance to a cross-flow fan proximal to the ground, and propel shredded plant matter a larger vertical distance.

Such embodiments are useful for efficiently disposing of plant matter, and increasing its overall density (via shredding) to more efficiently use the yard waste bags 212. Furthermore, having the cross-flow fan and corresponding power supply close to the ground may offer improved safety and comfort as compared to carrying a yard waste clearing device 200. Also, having a known disposition of the yard waste bag 212 relative to the cross-flow fan allows the chute 206 to be solid and fixed, which may produce smoother airflow and prevent buildup inside the chute 206.

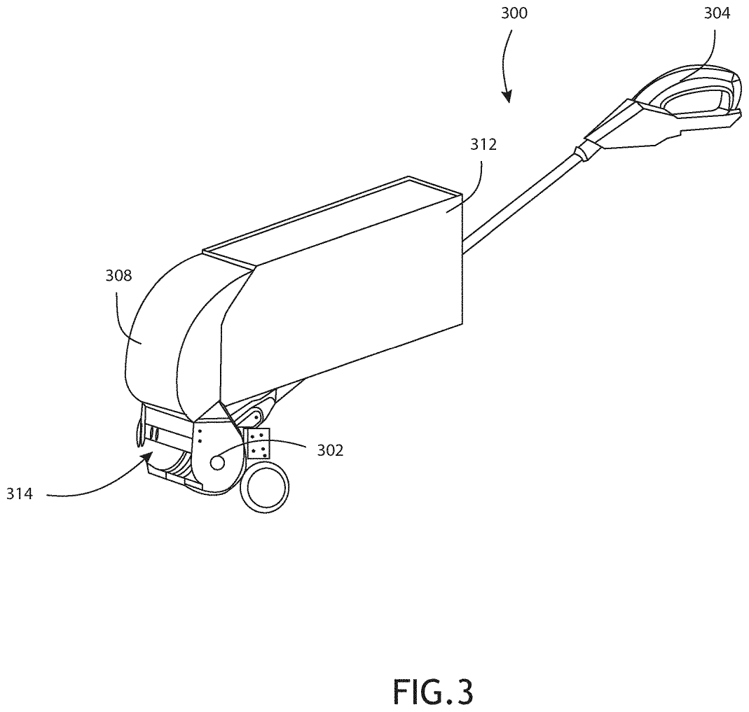

Referring to FIG. 3, a perspective view of a yard waste clearing device according to an exemplary embodiment is shown. The yard waste clearing device 300 includes a cross-flow fan cutting assembly having airfoil shaped blades that rotate about a horizontal axis, and control column 304 to allow steering. In at least one embodiment, the yard waste clearing device 300 may include a yard waste bag platform or an integrated shredded matter storage chamber 312 disposed in a desirable position with respect to a cross-flow fan housing 302 in a desired position and orientation, and a chute 308 leading from an outlet portion of the cross-flow fan housing 302 to the yard waste bag or storage chamber 312. The disposition and orientation of the yard waste bag or storage chamber 312 may be such so as to minimize the vertical distance of the chute 308.

The cross-flow fan housing 302 may include wheels that allow an inlet portion 314 to be pivoted about the wheels. The inlet portion 314 may be forward facing to more easily allow plant matter to enter the inlet portion 314 with a lower overall airflow.

Such embodiments are useful for efficiently disposing of plant matter, and increasing its overall density (via shredding) to more efficiently use the yard waste bags or storage chamber 312. Furthermore, having the cross-flow fan and corresponding power supply close to the ground may offer improved safety and comfort as compared to carrying a plant matter vacuum device.

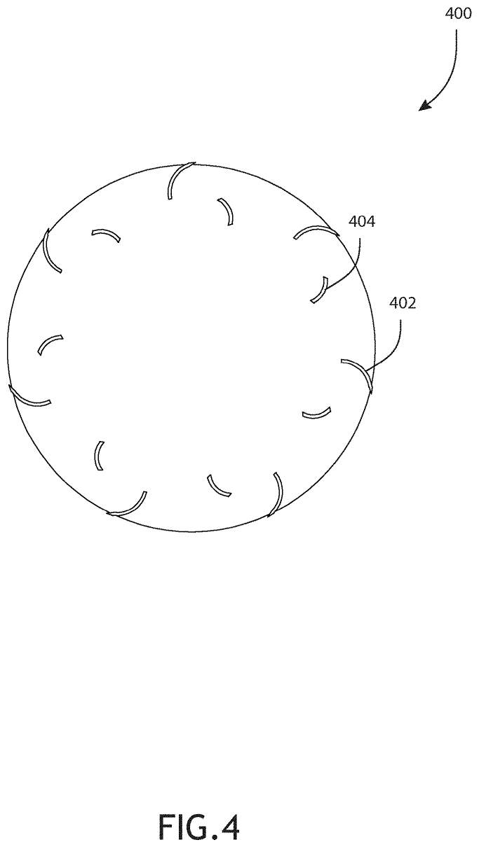

Referring to FIG. 4, a side view of a blade assembly 400 according to an exemplary embodiment is shown. In a blade assembly 400 with a plurality of cutting blades 402 and diverter blades 404, the diverter blades 404 may be configured to prevent grass clips from clumping around the cutting blades 402. In at least one embodiment, each cutting blade 402 is associated with a diverter blade 404. The diverter blades 404 may have opposite angular curvature as compared to the corresponding cutting blade 402; that is to say as the distance from the center of rotation increase, the curvature of the cutting blade 402 is toward the direction of rotation and the curvature of the diverter blade 404 is away from the direction of rotation.

In at least one embodiment, the distance from the center of rotation to a proximal edge of the cutting blade 402 is substantially similar to the distance from the center of rotation to a distal edge of the corresponding diverter blade 404. In at least one embodiment, the angular distance of the diverter blade 404 from the cutting blade 402 as measured from the center of rotation may be a function of the front angle of the cutting blade.

In at least one embodiment, cutting blades 402 with a front angle between 26 and 33 degrees demonstrated good cut quality and good anti-sticking characteristics. Furthermore, anti-sticking characteristics are best with a rear angle between 85 and 95 degrees.

In at least one embodiment, a cutting blade 402 front angle of 33 degrees with a corresponding diverter blade 404 may be optimal. Cut quality may be suboptimal with a front angle greater than 35 degrees or less than 23 degrees.

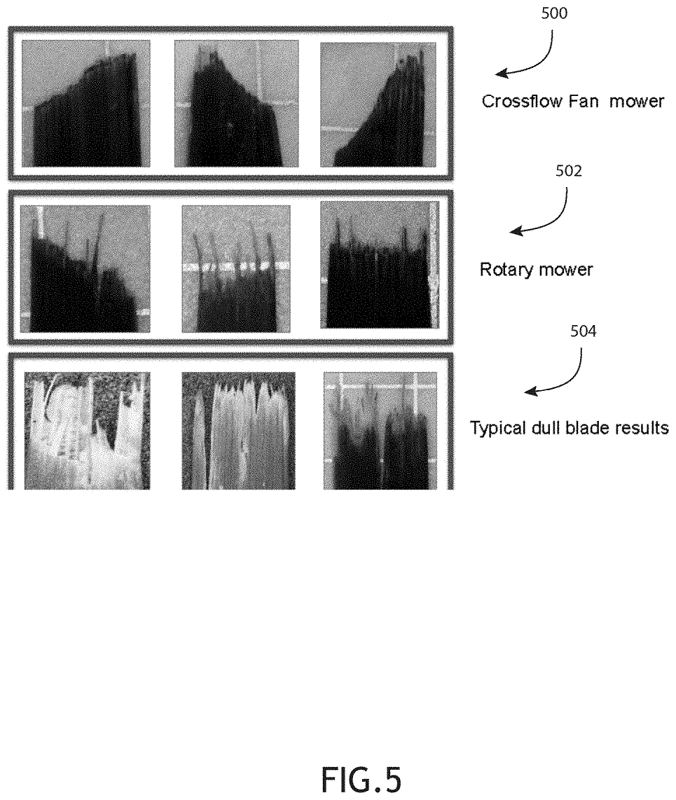

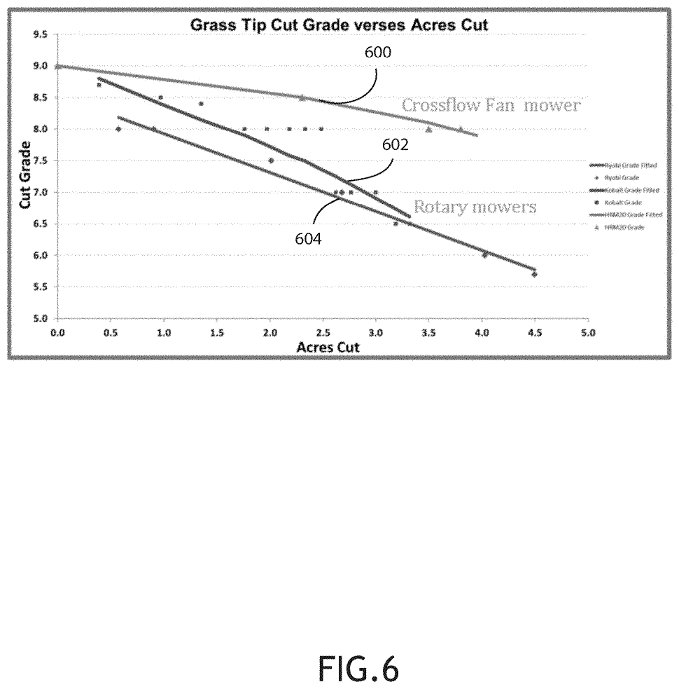

Referring to FIGS. 5 and 6, examples of grass cut quality utilizing varieties of mowers and a graph of cut quality degradation due to blade dulling over acres cut are shown. Cutting devices utilizing a cross-flow fan cutter assembly, such as mowers, offer similar performance to rotary mowers, but with superior cut quality (cross-flow fan cut quality 500 as compared to a standard rotary mower 502 and a dull blade rotary mower) and better cutting-edge retention (cross-flow fan mower cut quality across acres cut 600 as compared to competitive rotary mowers 602, 604). The slower blade tip speed of cross-flow fan cutters is safer than convention cutters, and requires less battery power to maintain. Such devices are also lighter and smaller than conventional devices with similar performance metrics because the cross-flow fan cutter is a horizontally mounted cylindrical assembly. Also, the cutting area of such devices is smaller than conventional cutting devices, enhancing safety.

Cross-flow fan cutting assemblies may utilize harder blades as they operate at slower speeds, which increases blade life. Furthermore, cross-flow fan cutters may be designed to produce an airflow that prevents material sticking to the blades such as through the addition of diverter blades, hence they are easier to maintain.

In at least one embodiment, a cross-flow fan having blades with a leading cutting edge and an airfoil cross-section is disposed in a plant matter shredding device (for example, in FIGS. 2A-2C and FIG. 3). The cross-flow fan creates an airflow that draws light plant matter into the blades. The cutting edge of each blade shreds the plant matter, both in the intake and at the outlet, as the airflow passes through the cross-flow fan. In at least one embodiment, the shredded plant matter is sufficiently small to be carried through a conduit to a disposal device (such as a yard waste bag).

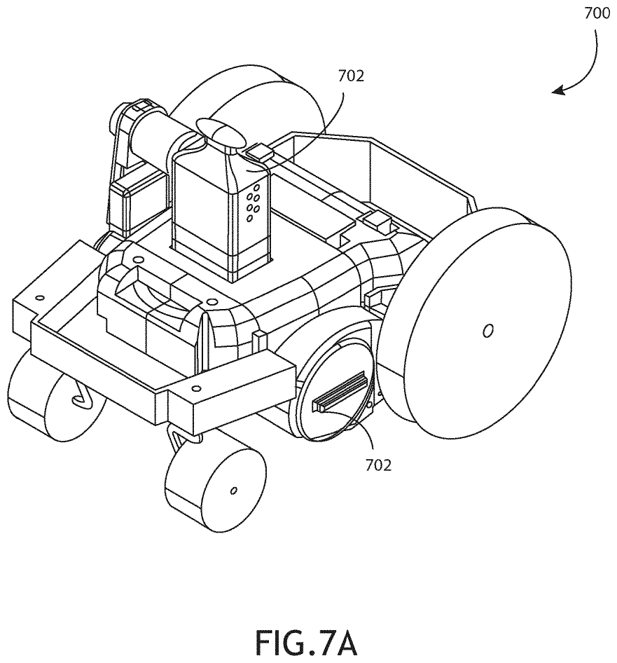

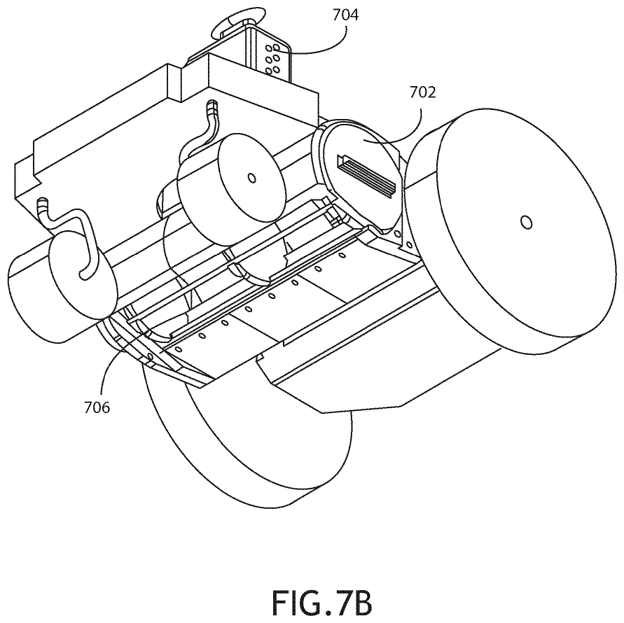

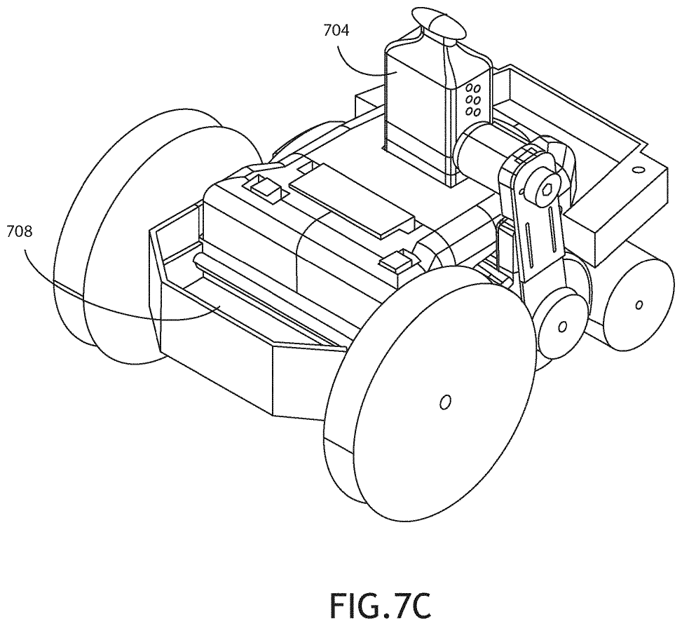

Referring to FIGS. 7A-7C, perspective views of a robot mowing device 700 according to an exemplary embodiment are shown. A robot mowing device 700 including a blade assembly having cross-flow fan having blades with a leading cutting edge and an airfoil cross-section may be generally smaller, more efficient, and offer longer battery life than and more robust operation as compared to existing robot mowing devices, allowing for smaller, lighter batteries 704. The robot mowing device 700 includes a blade assembly housing 702 that contains the cross-flow blade assembly and defines a blade assembly chamber with an inlet portion 706 and an outlet portion 708 that define an airflow path. In at least one embodiment, the outlet portion 708 is disposed to prevent the airflow outlet from re-entering the inlet portion 706, thereby spoiling the airflow. Alternatively, or in addition, an airflow spoiling flap may be disposed behind the inlet portion 706 relative to the direction of movement.

While the embodiments discussed herein have been generally directed to plant cutting/shredding, other embodiments may be useful in non-plant applications. For example, some embodiments may be useful in fluid movement applications where material in the fluid may need to be reduced. Other industrial applications are envisioned where flow is desirable in an environment where material in the flow may need to be reduced.

It is believed that the inventive concepts disclosed herein and many of their attendant advantages will be understood by the foregoing description of embodiments of the inventive concepts disclosed, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The form herein before described being merely an explanatory embodiment thereof, it is the intention of the following claims to encompass and include such changes. Furthermore, any of the features disclosed in relation to any of the individual embodiments may be incorporated into any other embodiment.

What is claimed is:

1. A cross-flow fan apparatus comprising:
a cross-flow blade assembly having:
plurality of blades, each of the plurality of blades comprising:
a cutting edge disposed on a leading edge of the blades; and
an airfoil cross-section; and
at least two rotors configured to maintain the plurality of blades in a fixed position and orientation relative to each other,
wherein the plurality of blades are spaced apart to allow material cut by the cutting edge to pass through via an airflow defined by the airfoil cross-section of the blades.

2. The cross-flow fan apparatus of claim 1, further comprising a housing defining a blade assembly chamber, the blade assembly chamber defining an inlet portion and an outlet portion, wherein the blade assembly chamber directs the airflow from the inlet portion to the outlet portion.

3. The cross-flow fan apparatus of claim 2, further comprising a chute disposed at the outlet portion configured to direct the material cut by the cutting edge.

4. The cross-flow fan apparatus of claim 3, further comprising a storage element disposed at a terminus of the chute to receive the material cut by the cutting edge.

5. A lawn debris clearing apparatus comprising:
a cross-flow blade assembly having:
plurality of blades, each of the plurality of blades comprising:
a cutting edge disposed on a leading edge of the blades; and
an airfoil cross-section; and
at least two rotors configured to maintain the plurality of blades in a fixed position and orientation relative to each other,
wherein the plurality of blades are spaced apart to allow yard waste cut by the cutting edge to pass through via an airflow defined by the airfoil cross-section of the blades.

6. The lawn debris clearing apparatus of claim 5, further comprising a housing defining a blade assembly chamber, the blade assembly chamber defining an inlet portion and an outlet portion, wherein the blade assembly chamber directs the airflow from the inlet portion to the outlet portion.

7. The lawn debris clearing apparatus of claim 6, further comprising a chute disposed at the outlet portion configured to direct the yard waste cut by the cutting edge.

8. The lawn debris clearing apparatus of claim 7, further comprising a yard waste bag support platform, wherein:
the chute is disposed to direct the yard waste cut by the cutting edge into an opening of the yard waste bag; and
the support platform is disposed and configured to retain the yard waste bag in a substantially upright orientation during normal usage.

9. The lawn debris clearing apparatus of claim 7, wherein the chute comprises a substantially constant cross-section to retain an airflow rate of the airflow.

10. The lawn debris clearing apparatus of claim 7, further comprising a top assembly disposed on a terminus of the chute to further direct yard waste cut by the cutting edge into opening of the yard waste bag.

11. The lawn debris clearing apparatus of claim 6, wherein the inlet portion is disposed in a forward surface of the housing.

12. The lawn debris clearing apparatus of claim 6, wherein:
the inlet portion is disposed in a bottom surface; and
the housing comprises a plurality of height adjustable wheels configured to adjust a height of the inlet portion above a ground level to alter an airflow rate of the airflow.

13. A lawn mowing apparatus comprising:
a cross-flow blade assembly having:
plurality of blades, each of the plurality of blades comprising:
a cutting edge disposed on a leading edge of the blades; and
an airfoil cross-section; and
at least two rotors configured to maintain the plurality of blades in a fixed position and orientation relative to each other,
wherein the plurality of blades are spaced apart to allow grass leaves cut by the cutting edge to pass through via an airflow defined by the airfoil cross-section of the blades.

14. The lawn debris clearing apparatus of claim 13, further comprising a housing defining a blade assembly chamber, the blade assembly chamber defining an inlet portion and an outlet portion, wherein the blade assembly chamber directs the airflow from the inlet portion to the outlet portion.

15. The lawn debris clearing apparatus of claim 14, further comprising a chute disposed at the outlet portion configured to direct the grass leaves cut by the cutting edge.

16. The lawn debris clearing apparatus of claim 15, further comprising a yard waste bag support platform, wherein:
the chute is disposed to direct the grass leaves cut by the cutting edge into an opening of the yard waste bag; and
the support platform is disposed and configured to retain the yard waste bag in a substantially upright orientation during normal usage.

17. The lawn debris clearing apparatus of claim 16, further comprising a yard waste bag support frame configured to retain the opening of the yard waste bag open and proximal to the chute.

18. The lawn debris clearing apparatus of claim 15, wherein the chute comprises a substantially constant cross-section to retain an airflow rate of the airflow.

19. The lawn debris clearing apparatus of claim 15, further comprising a top assembly disposed on a terminus of the chute to further direct yard waste cut by the cutting edge into opening of the yard waste bag.

20. The lawn debris clearing apparatus of claim 14, wherein:
the inlet portion is disposed in a bottom surface; and
the housing comprises a plurality of height adjustable wheels configured to adjust a height of the inlet portion above a ground level to alter an airflow rate of the airflow.
